(19) United States
(12) Patent Application Publication
(10) Pub. No.: US 2022/0184565 A1
(43) Pub. Date: Jun. 16, 2022

(54) PORTABLE MULTI-FUNCTIONAL SMART DECANTER

(71) Applicant: Shenzhen Jinshengxing Photoelectric Industry Co., Ltd., Shenzhen (CN)

(72) Inventors: Zhiwei LIU, Shenzhen (CN); Tao Luo, Shenzhen (CN); Shaowu Zeng, Shenzhen (CN)

(21) Appl. No.: 17/141,470

(22) Filed: Jan. 5, 2021

(30) Foreign Application Priority Data
Dec. 14, 2020 (CN) 202022993624.1

(51) Int. Cl. B01F 9/00; B01F 9/10; B01F 15/00

(52) U.S. Cl. CPC B01F 9/0016; B01F 9/10; B01F 15/00772; B01F 2215/007; B01F 15/00519; B01F 2215/0022; B01F 15/00538

(57) ABSTRACT

The present disclosure relates to the technical field of beverage mixers, in particular to a portable smart decanter, including a tray, a ball cover, balls, a rotary disc, a cam, a bearing, a motor, a motor cover, a diffusion ring, a USB charging port, a display, a key, a smart control drive, an upper cover, a lower cover, foot pads and a battery cover. The bottom center buckle of the lower cover is used to fix the battery cover. Through structure and function combination of various modules, when an object is placed on the tray of the on-off switch module, the force-bearing spring on the on-off switch module will touch the switch and make the internal circuit connected, and then the motor on the eccentric cam module begins to rotate and drive the ball sliding structure to slide.

### RELATED APPLICATIONS

This application claims priority to Chinese Patent Application 202022993624.1, filed on Dec. 14, 2020, which is incorporated herein by reference.

### TECHNICAL FIELD

The present disclosure relates to the technical field of beverage mixers, in particular to a portable smart decanter.

### BACKGROUND

With the increasing development of technology and living standards, people's pursuit of wine, coffee, champagne and other beverage culture is getting stronger and stronger, and their understanding is getting deeper and deeper. Smart portable mixers are getting more and more attention because they are characterized by compactness, portability, simple control and high stability. They can effectively reduce the carbon dioxide content in red wine, coffee and other beverages through a short period of shaking, so as to achieve the best taste. However, in terms of smart portable mixers, there is still a huge gap in the market to be filled. At present, what we can see in the market are expensive products in the original manual control mode, which are inefficient and not smart. In view of this, it is urgent to improve the existing mixer structure to improve the degree of automation and mixing efficiency.

To sum up, the present disclosure solves the existing problems by designing a portable smart decanter.

### SUMMARY

The purpose of the present disclosure is to provide a portable smart decanter to solve the problems raised in the background art.

In order to achieve the above objectives, the present disclosure provides the following technical scheme:

A portable smart decanter, including a tray, a ball cover, balls, a rotary disc, a cam, a bearing, a motor, a motor cover, a diffusion ring, a universal serial bus (USB) charging port, a display, a key, a smart control drive, an upper cover, a lower cover, foot pads and a battery cover. The bottom center buckle of the lower cover is used to fix the battery cover; the bottom of the lower cover is provided with four foot pads at equal angles based on the round shape of the battery cover; a smart control drive is arranged inside the lower cover; a USB charging port is embedded in a side wall of the lower cover; an upper cover is installed on the end face of the lower cover; a display is embedded in the front of the upper cover; a key is provided below the display and the upper cover; a diffusion ring is installed at the end of the upper cover; a motor cover is arranged at the bottom center inside the lower cover; a motor is installed on the motor cover; the end face of the motor cover corresponds to the motor and is connected at the bottom of the rotary disk through a connecting column; the driving end of the motor runs through the rotary disk and extends above the rotating disc, and is connected with the cam; a bearing is sleeved on the cam; five ball mounting holes are arranged at equal angles on the end face of the rotary disc, with the cam as the center; the five ball mounting holes are equipped with balls inside; a ball cover is installed above the balls and on the end face of the rotary disc; the end face of the ball cover and the interior of the diffusion ring are connected to the end face of the tray; the bottom center of the tray is connected to the bearing; the bottom of the motor cover is provided with a touch switch.

Preferably, the bottom center of the lower cover is provided with a battery mounting slot corresponding to the battery cover; a rechargeable lithium battery is arranged inside the battery mounting slot; the battery cover, the battery mounting slot and the rechargeable lithium battery comprise a battery module.

Preferably, the cam, the bearing and the motor form an eccentric cam rotating module; the balls, the ball cover and the rotary disc constitute a ball sliding module; the display belongs to a display control system module; a spring is arranged between the touch switch and the motor cover; the touch switch and the spring form an on-off switch module; the smart control drive belongs to a smart control drive module; a color-changing light emitting diode (LED) strip is embedded on the side wall of the upper cover.

Preferably, the eccentric cam rotating module, the smart control drive module, the ball sliding module, the on-off switch module, the display control system module and the battery module are connected together through terminal wires, and each module is independent from each other. The smart control drive module comprises a smart chip.

Preferably, the diameter of the five ball mounting holes is slightly larger than that of the balls, and the bottom connection mode of the balls and the ball cover is sliding connection.

Preferably, the internal fitting mode of the diffusion ring and the tray is clearance fit; the connection mode of the driving end of the motor and the rotary disc is rotary connection; the fitting mode of the bottom of the cam and the rotary disc is clearance fit.

Preferably, the foot pads are made of rubber material.

Compared with the prior art, the present disclosure has the following beneficial effects:

1. In the present disclosure, through structure and function combination of various modules, when an object is placed on the tray of the on-off switch module, the force-bearing spring on the on-off switch module will touch the switch and make the internal circuit connected, and then the motor on the eccentric cam module begins to rotate and drive the ball sliding structure to slide. Because the eccentric cam structure drives the rotary disc to rotate along an elliptic path, and precisely controls the rotation of the rotary disc through the smart control drive, it can fully shake the beverages such as red wine, coffee, and champagne to effectively reduce carbon dioxide and other impurities, so as to achieve the best taste.

### BRIEF DESCRIPTION OF THE DRAWINGS

FIG. 1 is a schematic diagram of the overall structure of the present disclosure;

FIG. 2 is an exploded view of FIG. 1 of the present disclosure;

FIG. 3 is a schematic diagram of the eccentric cam rotating structure of the present disclosure;

FIG. 4 is a schematic diagram of the ball sliding structure of the present disclosure;

FIG. 5 is a schematic diagram of the on-off structure of the present disclosure;

FIG. 6 is a schematic circuit diagram of the present disclosure.

In the figure: 1. Tray; 2. Ball cover; 3. Ball; 4. Rotary disc; 5. Cam; 6. Bearing; 7. Motor; 8. Motor cover; 9. Diffusion ring; 10. USB charging port; 11. Display; 12. Key; 13. Smart control drive; 14. Upper cover; 15. Lower cover; 16. Foot pad; 17. Battery cover; 18. Ball mounting hole; 19. Touch switch; 101. Battery mounting slot.

### DETAILED DESCRIPTION

A clear and complete description of the technical scheme in the embodiments of the present disclosure will be given below in combination with the accompanied drawings therein. Obviously, the described embodiments are only part of the embodiments of the present disclosure, rather than all of them. Based on the embodiments of the present disclosure, all other embodiments obtained by ordinary technical personnel in the art without creative work shall fall within the protection scope of the present disclosure.

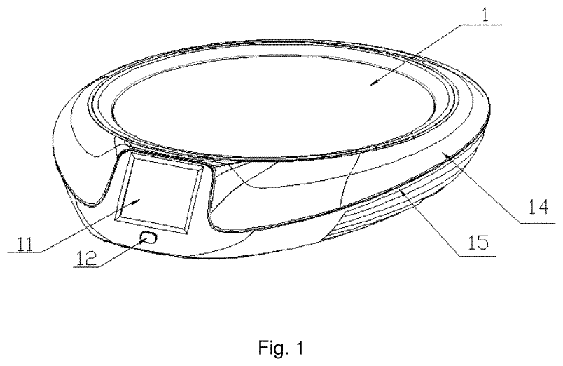

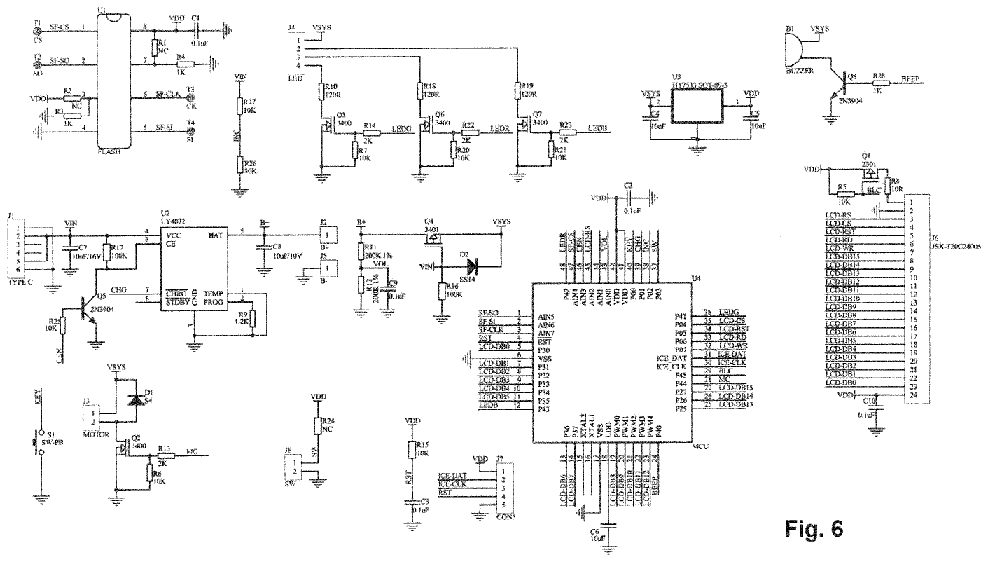

Please refer to FIG. 1-6. The present disclosure provides a technical scheme:

A portable smart decanter, including a tray 1, a ball cover 2, balls 3, a rotary disc 4, a cam 5, a bearing 6, a motor 7, a motor cover 8, a diffusion ring 9, a USB charging port 10, a display 11, a key 12, a smart control drive 13, an upper cover 14, a lower cover 15, foot pads 16 and a battery cover 17. The bottom center buckle of the lower cover 15 is used to fix the battery cover 17; the bottom of the lower cover 15 is provided with four foot pads 16 at equal angles based on the round shape of the battery cover 17; a smart control drive 13 is arranged inside the lower cover 15; a USB charging port 10 is embedded in a side wall of the lower cover 15; an upper cover 14 is installed on the end face of the lower cover 15; a display 11 is embedded in the front of the upper cover 14; a key 12 is provided below the display 11 and the upper cover 14; a diffusion ring 9 is installed at the end of the upper cover 14; a motor cover 8 is arranged at the bottom center inside the lower cover 15; a motor 7 is installed on the motor cover 8; the end face of the motor cover 8 corresponds to the motor 7 and is connected at the bottom of the rotary disk 4 through a connecting column; the driving end of the motor 7 runs through the rotary disk 4 and extends above the rotating disc 4, and is connected with the cam 5; a bearing 6 is sleeved on the cam 5; five ball mounting holes 18 are arranged at equal angles on the end face of the rotary disc 4, with the cam 5 as the center; the five ball mounting holes 18 are equipped with balls 3 inside; a ball cover 2 is installed above the balls 3 and on the end face of the rotary disc 4; the end face of the ball cover 2 and the interior of the diffusion ring 9 are connected to the end face of the tray 1; the bottom center of the tray 1 is connected to the bearing 6; the bottom of the motor cover 8 is provided with a touch switch 19.

Further, the bottom center of the lower cover 15 is provided with a battery mounting slot 101 corresponding to the battery cover 17; a rechargeable lithium battery is arranged inside the battery mounting slot 101; the battery cover 17, the battery mounting slot 101 and the rechargeable lithium battery form a battery module.

Further, the cam 5, the bearing 6 and the motor 7 form the eccentric cam rotating module; the balls 3, the ball cover 2 and the rotary disc 4 form the ball sliding module; the display 11 belongs to the display control system module, which can accurately display the operating condition of the mixer; a spring is arranged between the touch switch 19 and the motor cover 8; the on-off switch module is composed of the touch switch 19 and the spring, and different functions can be selected by pressing different times of the key 12; when an object is placed on the tray, the force-bearing spring inside the on-off switch module will touch the switch 19 and make the internal circuit connected; the smart control drive 13 belongs to a smart control drive module; a color-changing LED strip is embedded on the side wall of the upper cover 14, which can not only serve as a reminder for different stages of mixing through display of different colors on the light strip, but also serve as ambient lighting.

Further, the eccentric cam rotating module, the smart control drive module, the ball sliding module, the on-off switch module, the display control system module and the battery module are connected together through terminal wires, and each module is independent from each other. The smart control drive module comprises a smart chip, and various functions can be realized through the internal software of the internal chip;

Further, the diameter of the five ball mounting holes 18 is slightly larger than that of the balls 3, and the bottom connection mode of the balls 3 and the ball cover 2 is sliding connection to achieve flexible sliding;

Further, the internal fitting mode of the diffusion ring 9 and the tray 1 is clearance fit; the connection mode of the driving end of the motor 7 and the rotary disc 4 is rotary connection; the fitting mode of the bottom of the cam 5 and the rotary disc 4 is clearance fit;

Further, the foot pads 16 are made of rubber material to prevent slipping and to make the mixer more stable at work.

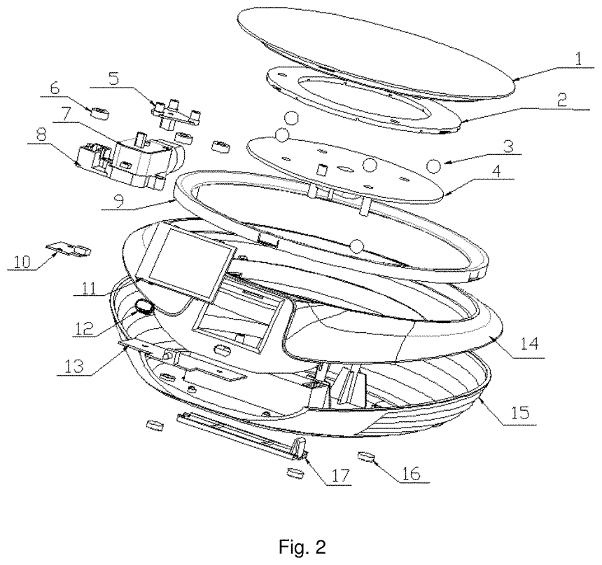

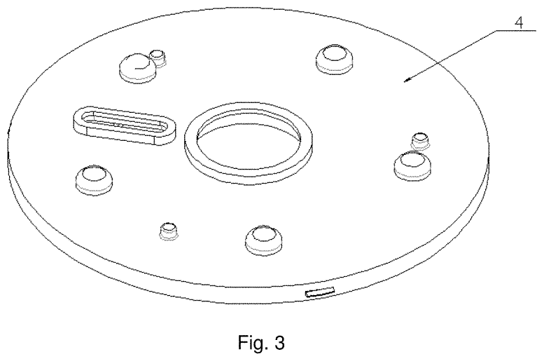

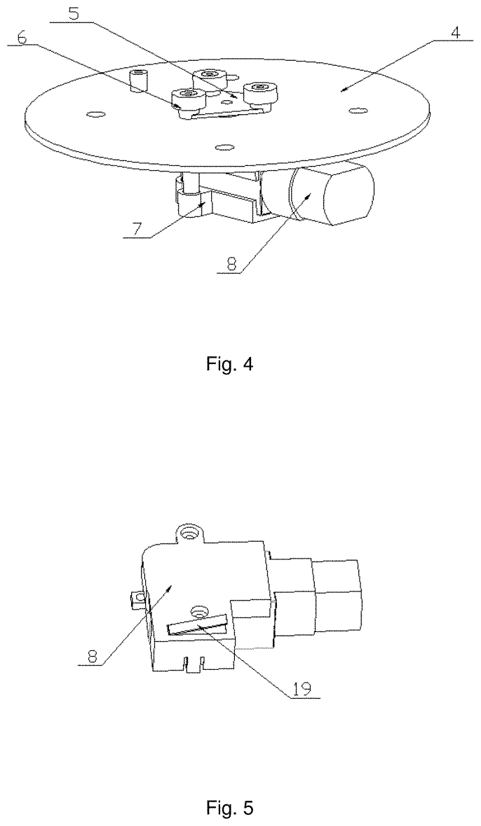

Workflow of the present disclosure: when an object is placed on the tray 1, the force-bearing spring (FIG. 4) inside the on-off switch module will touch the switch 19 and make the internal circuit connected; the diameter of the five ball mounting holes 18 is slightly larger than that of the balls 3, and the bottom connection mode of the balls 3 and the ball cover 2 is sliding connection to achieve flexible sliding; the internal fitting mode of the diffusion ring 9 and the tray 1 is clearance fit; the connection mode of the driving end of the motor 7 and the rotary disc 4 is rotary connection; the fitting mode of the bottom of the cam 5 and the rotary disc 4 is clearance fit; then the motor 7 on the eccentric cam module (FIG. 2) begins to rotate, and the cam 5 fixed on the motor drives the balls 3 on the ball sliding structure (FIG. 3) to rotate. Because the eccentric cam structure drives the rotary disc to rotate along an elliptic path, the rotation speed of motor 7 is precisely controlled by the smart control drive 13 adjusted by key 12, and the display 11 shows real-time control status, during the rotation, the mixer can, on one hand, fully shake the beverages such as red wine, coffee, and champagne to effectively reduce carbon dioxide and other impurities, so as to achieve the best taste; on the other hand, control the oscillation range so as not to spill the beverages. When the object on the tray 1 is removed, the spring on the on-off module (FIG. 4) rebounds to make the touch switch break the circuit, and then the motor 7 stops rotating to save energy.

Although embodiments of the present disclosure have been shown and described, to the ordinary technical personnel in the art, it is understood that these embodiments may be changed, modified, replaced and varied in a manner consistent with the principles and spirit of the present disclosure, the scope of which is defined by the attached claims and their equivalents.

What is claimed is:

1. A portable smart decanter, comprising a tray, a ball cover, balls, a rotary disc, a cam, a bearing, a motor, a motor cover, a diffusion ring, a universal serial bus (USB) charging port, a display, a key, a smart control drive, an upper cover, a lower cover, four foot pads and a battery cover, wherein: a bottom center buckle of the lower cover is used to fix the battery cover; a bottom of the lower cover is provided with the four foot pads at equal angles based on a round shape of the battery cover; the smart control drive is arranged inside the lower cover; the USB charging port is embedded in a side wall of the lower cover; the upper cover is arranged on an end face of the lower cover; the display is embedded in a front of the upper cover; the key is provided below the display and the upper cover; the diffusion ring is installed at an end of the upper cover; the motor cover is arranged at a bottom center inside the lower cover; the motor is installed on the motor cover; an end face of the motor cover corresponds to the motor and is connected at a bottom of a rotary disk through a connecting column; a driving end of the motor runs through the rotary disk, extends above the rotating disc, and is connected with the cam; the bearing is sleeved on the cam; five ball mounting holes are arranged at equal angles on an end face of the rotary disc, with the cam as a center; the five ball mounting holes are equipped with the balls inside; the ball cover is arranged above the balls and on the end face of the rotary disc; an end face of the ball cover and an interior of the diffusion ring are connected to an end face of the tray; a bottom center of the tray is connected to the bearing; and a bottom of the motor cover is provided with a touch switch.

2. The portable smart decanter according to claim 1, wherein: a bottom center of the lower cover is provided with a battery mounting slot corresponding to the battery cover; a rechargeable lithium battery is arranged inside the battery mounting slot; and the battery cover, the battery mounting slot and the rechargeable lithium battery form a battery module.

3. The portable smart decanter according to claim 1, wherein: the cam, the bearing and the motor form an eccentric cam rotating module; the balls, the ball cover and the rotary disc constitute a ball sliding module; the display is part of a display control system module; a first spring is arranged between the touch switch and the motor cover; the touch switch and the first spring form an on-off switch module; an interior of the key is provided with a second spring; the smart control drive is part of a smart control drive module; and a color-changing light emitting diode (LED) strip is embedded on a side wall of the upper cover.

4. The portable smart decanter according to claim 3, wherein: the eccentric cam rotating module, the smart control drive module, the ball sliding module, the on-off switch module, the display control system module and a battery module comprising the battery cover are connected together through terminal wires; each of the eccentric cam rotating module, the smart control drive module, the ball sliding module, the on-off switch module, the display control system module and the battery module is independent from each other; and the smart control drive module comprises a smart chip.

5. The portable smart decanter according to claim 1, wherein: a diameter of the five ball mounting holes is larger than that of the balls, and a bottom connection mode of the balls and the ball cover is a sliding connection.

6. The portable smart decanter according to claim 1, wherein: an internal fitting mode of the diffusion ring and the tray is a clearance fit; a connection mode of the driving end of the motor and the rotary disc is a rotary connection; and a fitting mode of a bottom of the cam and the rotary disc is a clearance fit.

7. A portable smart decanter according to claim 1, wherein: the four foot pads are made of rubber material.

8. The portable smart decanter according to claim 4, wherein: a bottom center of the lower cover is provided with a battery mounting slot corresponding to the battery cover; a rechargeable lithium battery is arranged inside the battery mounting slot; and the battery cover, the battery mounting slot and the rechargeable lithium battery form the battery module.
